(19) United States
(12) Patent Application Publication
(10) Pub. No.: US 2005/0239426 A1
(43) Pub. Date: Oct. 27, 2005

(54) Dual polarization receiving means

(76) Inventors: Giuliano Berretta, Paris (FR); Jacques Dutronc, Versailles (FR); Gary Patrick Stafford, St Albans (GB); David Gerald Smith, Knebworth (GB)

Correspondence Address: SWIDLER BERLIN LLP, 3000 K STREET, NW, BOX IP, WASHINGTON, DC, 20007, US

(21) Appl. No.: 10/849,926

(22) Filed: May 21, 2004

Related U.S. Application Data
(60) Provisional application No. 60/564,956, filed on Apr. 26, 2004.

(30) Foreign Application Priority Data
May 11, 2004 (GB) 0410377.6

(51) Int. Cl. H04B 1/00; H04B 1/16; H04B 1/10

(52) U.S. Cl. 455/227; 455/140; 455/296

(57) ABSTRACT

Apparatus provides the capability to receive data signals in more than one format and the capability to receive data signals of two or more formats and/or over two or more frequency bandwidth ranges so as to allow a plurality of broadcast data receivers to be connected to receive data and to be operated independently of the other apparatus.

### CROSS-REFERENCE TO RELATED APPLICATIONS

The benefit under 35 U.S.C. § 119(e) of provisional application No. 60/564,956, filed Apr. 26, 2004, is hereby claimed.

### FIELD OF THE INVENTION

The invention to which this patent application relates is concerned with the reception and processing of digital data, which is transmitted from a remote location, typically via a satellite transmission system. The data is received at a premises for subsequent processing and the generation of video and/or audio to be displayed to a user of the apparatus at the premises.

### BACKGROUND OF THE INVENTION

Conventionally, the receiving apparatus at a premises includes external mounted apparatus and internal apparatus. The external apparatus includes an antenna or “dish” provided with a waveguide and Low Noise Block (LNB). The external apparatus transfers the received data to the internal apparatus, typically via a cable connection. The user interacts with the internal apparatus which is the broadcast data receiver and signals can be generated which are indicative of the user interaction to allow the control and selection of certain operating conditions of the LNB and which are sent via the cable to the LNB.

The data is typically transmitted from the satellite or multiple satellites to the external receiving apparatus or multiple receiving apparatus in either a circular polarity format (such as in the U.S.) or in a linear polarity format (such as in the majority of European countries). Both systems are effective, but there is a problem with conventional circular polarity format systems in that the available bandwidth is relatively limited, typically being 12.2 to 12.7 GHz as opposed to 10.7 to 12.7 GHz in linear polarity format systems. However it should be noted that the application is not limited to these bands and is also applicable to CP and LP bands that are intermixed. As the demand for the range of available programs increases, and hence the level of data required to be transmitted at any give time increases so it is being found that the available bandwidth of the circular polarity format system is insufficient. However due to the large scale of existing usage of the circular polarity format and the large number of circular polarity format receiving apparatus already fitted in premises it is commercially impractical to start transmitting all data in a linear polarity format only as all of the existing apparatus would not be usable.

Furthermore, while it is known to provide an LNB which can receive either linear or circular polarity format transmissions, the known LNB needs to be switched between two receiving conditions, one for receiving linear polarity format and one for receiving circular polarity format. This means that at any one time the LNB can only receive and process one of the linear or circular polarity format signals. This therefore means that all receiving apparatus connected to the LNB has to receive the same linear or circular polarity format signals at any given time and therefore can only receive the subset of transmit data which has been transmitted in that format. When one considers that, increasingly, premises have a plurality of broadcast data receivers connected to the external apparatus and each of the receivers is operable independently of the others to allow differing user selections to be made at the same time on the different receivers, the current LNB operating parameters are unsatisfactory. It is also known from the published patent application U.S. 2004/0029549 that there is a possible system, which is capable of receiving signals, which are orthogonal at the input, and then uses diplexers to split the band into two. The use of the diplexer requires that there is a gap between the received bands of at least 10% which means that in practical terms the system of this patent application, for many desired uses, does not represent a practical solution to the current problems as the received frequency bands are often required to have no gap between the same.

### SUMMARY OF THE INVENTION

The invention to which this patent application relates is concerned with the reception and processing of digital data, which is transmitted from a remote location, typically via a satellite transmission system. The data is received at a premises for subsequent processing and the generation of video and/or audio to be displayed to a user of the apparatus at the premises.

Once received at the premises the data is processed by a broadcast data receiving system, where the data can be processed to allow the generation of the video, audio and/or auxiliary data. In one particular, although not exclusive, utilization the video, audio and/or auxiliary data can be used to generate a television or radio program, with the particular program generated in response to user selection made by the user via the receiving apparatus.

The aim of the present invention is to provide receiving apparatus which has the capacity to receive data signals in more than one format and to provide the LNB with the capability to receive data signals of two or more formats and/or over two or more frequency bandwidth ranges so as to allow a plurality of broadcast data receivers to be connected to receive data from the LNB and to be operated independently of the other said apparatus.

In a first aspect of the invention there is provided receiving apparatus for data signals transmitted via satellite at frequencies within a predetermined frequency range, said receiving apparatus including an LNB which receives and processes data signals over the range of frequencies simultaneously and wherein said data signals are from at least two polarity formats and said data is processed through the LNB and is available for selection at any given time to generate audio and/or video in response to at least one user selection via the receiving apparatus.

In one embodiment the data signals are received over any or any combination of bandwidths or overlapping bandwidths, in a combination of circular polarity and linear polarity formats. In one embodiment, alternate transponders on the satellite from which the data signals are received could have circular polarity or linear polarity formats and the data signals can be received by the current apparatus.

In one embodiment, the LNB is provided with a series of Intermediate Frequency (IF) data outlets from which the received data signals can be transferred to a broadcast data receiver (BDR) in response to a user selection via the BDR.

Typically each of the outlets is independently controllable such that each outlet is connectable to a BDR and each BDR can receive data from the respective LNB outlet, the data being determined in response to the operating condition of the particular BDR. In accordance with the invention each BDR can receive data in response to a user selection made via that BDR and the data or range of program selections available is not affected or influenced by the operating condition of the other BDR's connected to the other outlets of the LNB, as the LNB is capable, as a result of this invention of receiving and processing data from different bandwidths and/or in different polarity format simultaneously so that all of the data is always available to each of the BDR's connected to the LNB.

Typically, the data signals, whether from different frequency ranges and/or of linear or circular polarity formats are processed in the LNB using linear polarity and circular polarity processing circuitry.

If the data signals received include some data signals having a linear polarity format and some having a circular polarity format, the data subsequently used by a BDR is determined by the user selection of a particular program and in which format the data for that program has been transmitted to the BDR. For example, if the television program channel selected is generated from data carried via data signals with a circular polarity format then the data signal block processed by the circular polarity processing circuit in the LNB is selected and transmitted to the BDR to be used in the generation of the video and audio for the selected television program.

Typically all of the received data is processed but only a certain proportion of the same is used at each instant by each BDR.

Typically, for each set of data signals, which are transmitted with circular polarity, the LNB includes a hybrid.

In one embodiment the data signals pass through a waveguide and waveguide probes, which are used to split the received data signals into two data paths, which in the case of circular polarization have a 90° phase difference. Preferably the data from each of the data probes then passes through first and/or second stage amplifiers which are phase and amplitude balanced and is then split into two data routes: a first route which passes the data to the hybrid and then on to further LNA stages which, for the data which is in a circular polarity format, acts to reform the data signal, and a second route which allows the correct passage of data with linear polarity format. Thus, for each data path, the data passes through circular and linear polarity format processing routes. In each route, if the data is of mixed linear and circular polarity, some of the data will be processed correctly and some will not. For example, linear polarity format data will not be meaningfully processed by the circular polarity data processing route and vice versa but at the end of the routes it is ensured that all of the data will have been processed correctly in either of the two processing formats and is therefore all available for subsequent processing to allow the generation of audio and/or video.

Typically the LNB includes switching means connected to each of the outlets to allow access to the appropriate data from the appropriate data processing route in response to the user selection.

In one embodiment the data is provided to the BDR in blocks, each block including all data in a received data set i.e. data at a particular frequency or data with a particular polarity and the particular data block selected is that which includes the data required to achieve the generation of the data for the user selection via the BDR.

In one embodiment of the invention the circuit used includes probes, which are located orthogonally. Preferably the phase matching of the probes is maintained across the band of operation, at the output of the probes on the microstrip. For this reason the probes need to be orthogonally located and in the same plane in the waveguide. This allows prevention or reduction within an acceptable level, of the frequency varying phase error in the waveguide and prevents propagation of the same onto the micro-strip, which cannot then be corrected.

Typically the LNB includes a feed horn, which is designed to allow the 90° CP phase difference to be maintained across the frequency band without any differential phase shift.

In one preferred embodiment 3 dB splitters are used to determine the data routes and as a result there is no reason to band limit the design.

As a result of the invention it is possible for the system to receive and process a mixture of CP and LP signals in the same band. i.e. it is possible for alternate satellite transponders to be on CP or LP polarizations.

Although described with reference to one power split it should be appreciated that the apparatus can include and can operate with more than one power split such that the power could be divided two or more ways, typically at a Wilkinson junction.

In the current apparatus a Diplexer does not have to be used and therefore there is no need for the provision of a gap between the frequency bands of operation as is the case in the prior art.

In one embodiment the apparatus is used to receive data at frequencies of 11.7-12.2 GHz in a linear polarity (LP) format and 12.2 GHz-12.7 GHz in a circular polarity (CP) format.

In a preferred embodiment, the amplifier stages of the apparatus, which are positioned prior to the splitting of the data paths, are phase and amplitude matched in order to maintain the 90° phase difference and amplitude balance for CP signals to be correctly processed.

### BRIEF DESCRIPTION OF THE DRAWINGS

Specific embodiments of the invention will now be described with reference to the accompanying diagrams; wherein

FIG. 1 illustrates in schematic manner, receiving apparatus provided at a premises and in an arrangement to which the current invention is well suited;

FIG. 2 illustrates a first embodiment of the data circuits in the LNB; and

FIG. 3 illustrates a second embodiment of the data circuits in the LNB.

### DETAILED DESCRIPTION OF THE PREFERRED EMBODIMENT

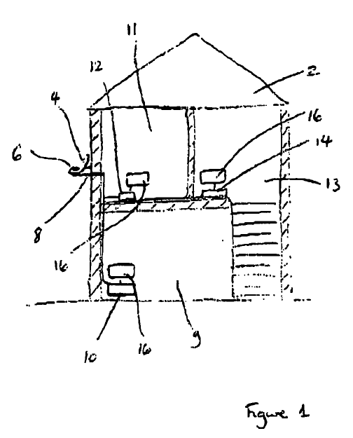

Referring firstly to FIG. 1 there is illustrated receiving apparatus in accordance with the invention at a premises 2. The apparatus includes an antenna 4 mounted externally of the premises and including an LNB 6 provided as part thereof. The antenna and LNB are provided and located to receive data, which is transmitted from one or a series of broadcasters and transmitted via satellite to each of the premises to be received by the antenna and LNB at each of said premises. The LNB is connected via a coaxial cable 8 to a series of broadcast data receivers (BDR's), 10,12, 14 provided within the premises, typically in different rooms as indicated. Each of the BDR's is provided for user interaction such that each, independently of the others, can be operated by a user to select a particular television program. Upon a user selection designating a particular program a signal is transmitted from the BDR to the LNB to allow the data or a block of data in which the required data is located, for the selected program to be provided to the BDR for processing and generation of the video and/or audio to allow the program to be generated to the user, typically via connected television 16.

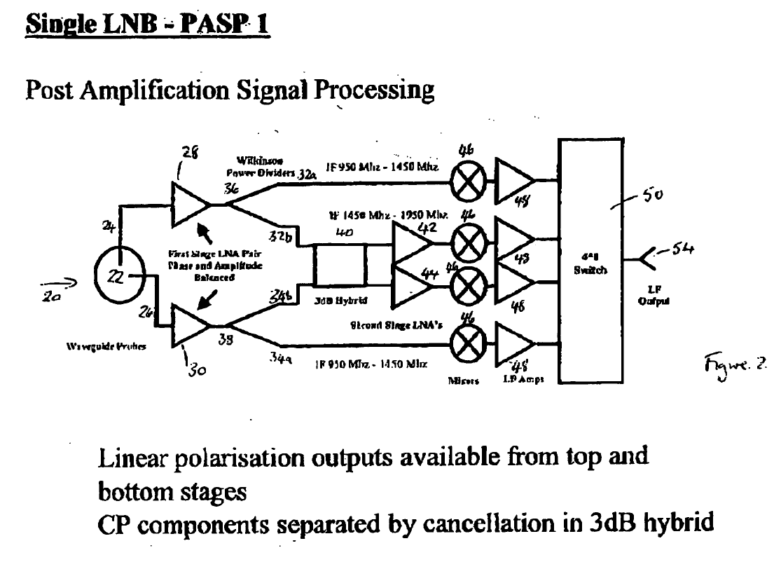

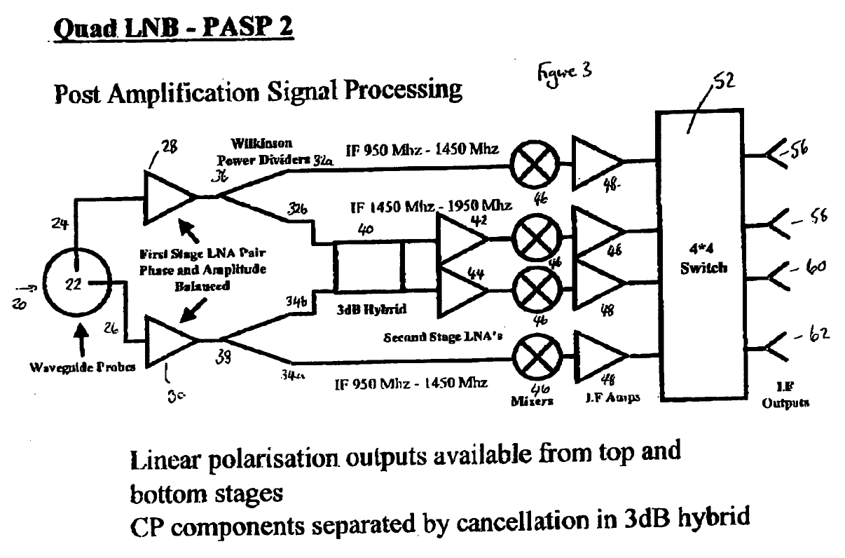

Referring now to FIGS. 2 and 3 there are illustrated two embodiments of the data circuits provided in the LNB in accordance with the invention and along which data received passes.

In each of the Figures common components are annotated with the same numerals for ease of reference.

The received data enters the LNB in the direction of arrow 20 at which point the data is split 22 into two data paths 24, 26 at 90° phase difference. It should be appreciated that all of the received data, is treated in the same way and passes along the two data paths 24,26 as defined by the waveguide probes 22.

The data in each of the data paths 24, 26 then passes through respective first stage (and/or second stage) pair Low Noise amplifiers (LNA's) 28, 30. The LNA pair 28,30 are phase and amplitude balanced.

Each of the data paths 24, 26 are then split into two data routes 32a, 32b and 34a and 34b respectively using Wilkinson power dividers 36, 38 respectively.

The two data routes 32a and 34a are set up to allow the correct processing of data which is in a linear polarity format. The two routes 32b and 34b are set up to allow the correct processing of data which is the circular polarity format and are provided with a 3 dB hybrid 40 and each route is provided with one of the pair of second stage LNA's 42,44 respectively. Each of the routes 32a, 32b, 34a, 34b is provided with a mixer 46 and Intermediate Frequency Amplifier 48 from where the data is accessed and selected via switch control means which will be described subsequently.

Thus along each data path 24, 26 the same received data passes and this data can be in circular and linear polarity formats. The LNA's serve to amplify the data significantly to allow the processing of the data accurately to be achieved and it is also important that the data paths and routes are symmetrical so as to ensure the minimal error in the data and thereby ensure that the data is acceptable for subsequent processing and within allowable error parameters.

The data, which for the sake of this example, is in circular and linear polarity formats and which will now be described passing along data path 24, once it has passed through the LNA 28 is split into two routes 32a and 32b. The data, which passes along the route 32a, is processed as if it is all in linear polarity format and therefore that which is in a linear polarity format will be processed correctly and that which is not will not be processed correctly. In route 32b the data is processed as if it is all in a circular polarity in which case that data which is in a circular polarity is processed correctly and the linear polarity format data is not.

This is repeated in data routes 34a and 34b such that the linear polarity format data is available from the outputs of data paths 32a and 34 a and the circular polarity data is available from the outputs of the routes 32b and 34b. The circular polarity data components are separated by the cancellation in the 3 dB hybrid as they pass along the routes 32b and 34b.

The provision of the dual processing routes in each data path and the symmetry of the two data paths and routes components when provided on the circuitry allows the simultaneous processing and provision of data whether in circular or linear polarity formats and/or whether provided in the same or different formats over different predetermined frequency ranges.

All of the data in the appropriate form is therefore available for selection at any given instant via the switch control means 50, in FIGS. 2 and 52 in FIG. 3.

In FIG. 2 the switch is a 4 by one switch which means that there is one IF output 54 to which one BDR can be connected. Thus, in this arrangement, a signal representative of a user selection at the BDR of a particular television program is transmitted to the switch 50. The signal allows the location of data required for that particular television program to be identified and the switch accesses the output from the data paths at which the required data or block of data, whether that be in circular or linear polarity format, is located. The identified data is then directed through the switch 50 to the BDR via the output 54 and the BDR can then process the data to generate the video and/or audio for the selected television program.

In FIG. 3 the switch 52 is a 4 by 4 switch which means that it has four IF outputs 56,58,60,62. Each of these IF outputs is connectable to a BDR and each allows the supply of data to the respective BDR independently of the others.

Thus, if for example, the BDR connected to IF output 56 is controlled to generate a user selected television program generated from data which has been received in a circular polarity format then that data is available having been processed via paths 32b and 34b and that data or data block from the appropriate data path output is directed to the IF output 56. If at the same time the BDR connected to the IF output 60 is controlled to generate a user selected program from data which has been received in a linear polarity format that data has been processed correctly via paths 32a and 32b and is therefore also available at the same instance and therefore the required data or data block is directed to the IF output 60.

In an alternative embodiment to the specific description herein and specifically with regard to the output arrangement, each of the IF data paths to the outlet can be combined by using diplexers at the output onto a single or any combination of multiple outputs. In this arrangement the switch arrangements as described in the Figures need not be provided.

Thus, in accordance with the invention there is provided an LNB and processing apparatus which allows the simultaneous reception, processing and availability of data which is transmitted in both linear and circular polarity formats, thereby allowing data over a greater frequency bandwidth to be available for selection and for selection and processing of data of different polarity formats to be achieved simultaneously. This therefore means that there is now the practical possibility to allow the continued broadcast of data in a circular polarity format over the existing bandwidth and the additional broadcast of data in a linear polarity format in the same geographical region and over a great frequency bandwidth thereby enlarging the data which can be transmitted, the user selections which are available and ensuring that the linear and circular polarity format data can be received and processed and be available in response to a user selection at all times and simultaneously.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A low noise block for a receiving apparatus for data signals transmitted via satellite at frequencies within a predetermined frequency range, the receiving apparatus comprising:
circuitry operable to receive and process data signals having at least two polarity formats over the predetermined range of frequencies simultaneously; and
circuitry operable to generate audio and/or video from the data signals in response to at least one user selection via the receiving apparatus.

2. The low noise block of claim 1, wherein the data signals are received over any bandwidths, any combination of bandwidths, or overlapping bandwidths within the predetermined range of frequencies, in a combination of circular polarity and linear polarity formats.

3. The low noise block of claim 2, wherein alternate transponders on the satellite from which the data signals are received have circular polarity or linear polarity formats, respectively.

4. The low noise block of claim 3, wherein the low noise block further comprises a plurality of Intermediate Frequency data outlets, each data outlet operable to output the received data signals to a broadcast data receiver in response to a user selection via the broadcast data receiver.

5. The low noise block of claim 4, wherein each of the data outlets is independently controllable to selectively output the received data signals to a connected broadcast data receiver, the data signals output being determined in response to an operating condition of each particular broadcast data receiver.

6. The low noise block of claim 5, wherein each broadcast data receiver is operable to receive data in response to a user selection made via that broadcast data receiver and wherein the data or range of program selections available is not affected by an operating condition of the other broadcast data receivers connected to the other data outlets of the low noise block.

7. The low noise block of claim 6, further comprising linear polarity processing circuitry operable to process data signals having linear polarity format circular polarity processing circuitry operable to process data signals having circular polarity format.

8. The low noise block of claim 7, wherein the received data signals include a data signal having a linear polarity format and a data signal having a circular polarity format and the low noise block is further operable to output data to a broadcast data receivers based on a user selection of a particular program and on the format in which the data for that program has been transmitted.

9. The low noise block of claim 6, wherein the low noise block further comprises a waveguide operable to split the received data signals into a first data path and a second data path.

10. The low noise block of claim 9, further comprising:
amplifier circuitry for each data path that is phase and amplitude balanced and is operable to amplify the corresponding data signal;
splitter circuitry for each data path operable to split the data signal into a first and a second data route, wherein the first data route is operable to reform the data signal for a data signal in circular polarity format, and wherein the second data route is operable to pass a data signal in the linear polarity format.

11. The low noise block of claim 9, wherein the amplifier circuitry for each data path is phase and amplitude matched so as to maintain a 90° phase difference and amplitude balance for data signals in a circular polarity format.

12. The low noise block of claim 11, further comprising:
switching circuitry connected to each of the data outlets and operable to provide access to the data from a selected data processing route in response to a user selection.

13. The low noise block of claim 12, wherein a data signal provided to a broadcast data receiver is provided in blocks, each block including data in a received data set including data at a particular frequency or data with a particular polarity, and a selected data block includes data required to achieve the generation of the data for the user selection via the broadcast data receiver.

14. The low noise block of claim 9, wherein the waveguide includes probes that are positioned orthogonally relative to each other.

15. The low noise block of claim 14, wherein the waveguide is operable to maintain phase matching of the probes across a frequency band of operation.

16. The low noise block of claim 15, further comprising a feed horn operable to allow a 90° circular polarization phase difference to be maintained across the frequency band of operation without substantial differential phase shift.

17. The low noise block of claim 15, wherein the splitter circuitry comprises 3 dB splitters.

18. The low noise block of claim 15, wherein the splitter circuitry is operable to split the data signal into a plurality of data routes.

19. The low noise block of claim 15, wherein there is no gap between frequency bands of operation.

20. The low noise block of claim 15, wherein a first received data signal is at frequencies of 11.7-12.2 GHz in a linear polarity (LP) format and a second received data signal is at frequencies of 12.2 GHz-12.7 GHz in a circular polarity (CP) format.
